(19) United States
(12) Patent Application Publication
(10) Pub. No.: US 2025/0249459 A1
(43) Pub. Date: Aug. 7, 2025

(54) MICROPLATE FILTER PLATE

(71) Applicant: CSTEC CORPORATION, Uji-shi, Kyoto (JP)

(72) Inventor: Yoshitaka TANIGUCHI, Uji-shi (JP)

(73) Assignee: CSTEC CORPORATION, Uji-shi, Kyoto (JP)

(21) Appl. No.: 18/855,820

(22) PCT Filed: Jul. 18, 2023
(86) PCT No.: PCT/JP2023/026264

§ 371 Date: Oct. 10, 2024

(30) Foreign Application Priority Data
Sep. 12, 2022 (JP) 2022-144791

(51) Int. Cl. B01L 3/00; B01D 29/03; B01D 29/52; B04B 3/00

(52) U.S. Cl. CPC B01L 3/50853; B01D 29/03; B01D 29/52; B01D 2201/34; B01L 2200/0689; B01L 2300/0681; B01L 2300/0829; B04B 3/00

(57) ABSTRACT

The microplate filter plate includes a base portion having a plate shape, the base portion including a first through hole provided at a position corresponding to each of a plurality of wells of a microplate, a filter provided in each of the first through holes, and a packing member having a plate shape and flexibility, the packing member being provided on one surface of the base portion and having a second through hole at a position corresponding to each of the first through holes.

### TECHNICAL FIELD

The present invention relates to a filter plate used for filtering a sample liquid when the sample liquid is put into a well of a microplate.

### BACKGROUND ART

Conventionally, when a sample liquid derived from a living body or the like is put into a well of a microplate, a filter for removing impurities contained in the sample liquid is used. Since, usually, the mesh of such a filter is small, the sample liquid cannot pass through the filter by simply dropping the sample liquid on the filter due to the surface tension. Therefore, conventionally, a pipette containing a sample liquid is pressed on a surface of the filter, and then the sample liquid is pushed out from the pipette. Another method is recently used in which a sample liquid is dropped onto a filter provided corresponding to each well, and then the sample liquid is drawn into the well by a centrifugal force applied using a centrifuge.

For example, Patent Literature 1 describes a microplate filter plate in which through holes are provided in a plate member, each through hole corresponding to each well of a microplate, and a filter is provided below each of the through holes. A guide wall extends downward from the periphery of each through hole on the lower face of the plate-shaped member. This filter plate is used in such a manner that the filter plate covers the microplate and each guide wall is inserted in a corresponding well. Then a sample liquid is dropped onto the filter of each through hole.

### CITATION LIST

### Patent Literature

Patent Literature 1: WO 2007/123100 A

### SUMMARY OF INVENTION

### Technical Problem

Usually, the microplate is set in a holder of the centrifuge in a state where the microplate is inclined near vertical (that is, the through hole is near horizontal) to the extent that the sample liquid in the through hole does not spill out. When the centrifuge is driven in this state, the holder rotates at a high speed about the vertical axis, and the sample liquid in the through hole (that is, on the filter) is drawn into the well through the filter by the centrifugal force. At this time, if there is a gap between the guide wall and the well, the sample liquid may leak from the gap and flow into an adjacent well. This causes different sample liquids mixed, and hampers accurate analysis.

An object of the present invention is to provide a microplate filter plate capable of preventing a sample liquid from being mixed when the sample liquid is filtered through a filter.

### Solution to Problem

A microplate filter plate according to the present invention made to solve the above problems includes:
a) a base portion having a plate shape, the base portion including a first through hole provided at a position corresponding to each of a plurality of wells of a microplate;
b) a filter provided in each of the first through holes; and
c) a packing member having a plate shape and flexibility, the packing member being provided on one surface of the base portion and having a second through hole at a position corresponding to each of the first through holes.

The microplate filter plate (hereinafter, referred to as “filter plate”) according to the present invention is used by overlaying the microplate. Specifically, the base portion overlays the microplate such that the side on which the packing member is provided faces the microplate, and each of the plurality of wells of the microplate and each of the second through holes match. In this state, a sample liquid (or sample liquids) is dropped from the first through hole(s) onto the filter(s), and the microplate with the packing member is set in a centrifuge in a state where the packing member abuts on the microplate and the filter plate is strongly pressed against the microplate. When the centrifuge is driven, the sample liquid(s) dropped on the filter(s) passes through the filter(s) by centrifugal force and is drawn into respective well(s). Since the packing member having flexibility is interposed between the filter plate and the microplate, liquid tightness is assured between the filter plate and the microplate. As a result, when a sample liquid that has passed through the filter is drawn into the well, the sample liquid is prevented from leaking out from between the filter plate and the microplate and flowing into an adjacent well, and it is possible to prevent different sample liquids from being mixed with each other.

Although it is possible to provide filters separated from each other one by one in each of the first through holes, it is preferable that one (integrated single) filter that covers all of the plurality of first through holes of the base portion is provided between the base portion and the packing member. By using such a single filter, it is possible to save time and effort for attaching the filter.

The filter plate according to the present invention may further include a cylinder extending from the periphery of each of the first through holes of the base portion toward the packing member and passing through the corresponding second through hole.

When the filter plate including such a cylinder is used, the cylinder is inserted into each of the plurality of wells of the microplate, and then the packing member is brought into contact with the surface of the microplate. When the microplate is set in the centrifuge, the packing member is pressed against the surface of the microplate. As a result, the sample liquid(s) passes through the filter(s) by centrifugal force, and then passes through respective cylinder(s), and is introduced into corresponding well(s). Even when such a cylinder is provided, it is possible to prevent a sample liquid from flowing into an adjacent well and to prevent different sample liquids from mixing with each other by providing the packing member.

In the filter plate including such a cylinder,
the base portion may be formed by overlapping a first base portion having a plate shape and a second base portion having the cylinder on one surface of a plate-shaped member, and the filter is provided between the first base portion and the second base portion.

By providing the filter between the first base portion and the second base portion in this manner, it is possible to save time and effort for attaching the filter. Note that the filters separated from each other may be provided one by one in each first through hole, but using one filter over a plurality of the first through holes can further save time and effort for attachment. In addition, the second base portion may be formed by assembling a plate-shaped member and a cylinder which are separated from each other, but it is preferable to form the plate-shaped member and the cylinder by integral molding since it is possible to save time and effort for assembly.

As a material of the packing member, for example, an elastomer such as silicone rubber, ethylene propylene rubber (EPM (also referred to as EPR) which is a copolymer of ethylene and propylene, or EPDM (also referred to as EPT) which is a terpolymer obtained by adding a small amount of a third component to ethylene and propylene), or urethane rubber can be suitably used.

### Advantageous Effects of Invention

With the microplate filter plate according to the present invention, it is possible to prevent sample liquids from being mixed when the sample liquids are filtered through the filter.

### BRIEF DESCRIPTION OF DRAWINGS

FIG. 1 A top view (a), a longitudinal sectional view taken along line a-a (b), and a bottom view (c), each showing a first embodiment of a microplate filter plate according to the present invention.

FIG. 2 A longitudinal sectional view illustrating a seal with filter/packing member including a filter and a packing member, which is attached to a base portion at the time of manufacturing the filter plate of the first embodiment.

FIG. 3 An exploded perspective view of the seal with filter/packing member in the first embodiment.

FIG. 4 A longitudinal sectional view illustrating a state in which the filter plate of the first embodiment is attached to a microplate.

FIG. 5 A schematic view illustrating a state in which the microplate and the filter plate of the first embodiment are attached to a centrifuge.

FIG. 6 A top view (a), a longitudinal sectional view taken along line b-b (b), and a bottom view (c), each showing a second embodiment of a filter plate according to the present invention.

FIG. 7 A partially enlarged longitudinal sectional view (a) and a partially enlarged bottom view (b) of the filter plate according to the second embodiment.

FIG. 8 A partially enlarged longitudinal sectional view illustrating a state in which the filter plate of the second embodiment is attached to a microplate.

FIG. 9 A partial longitudinal sectional view illustrating a filter plate according to a modification of the first embodiment.

### DESCRIPTION OF EMBODIMENTS

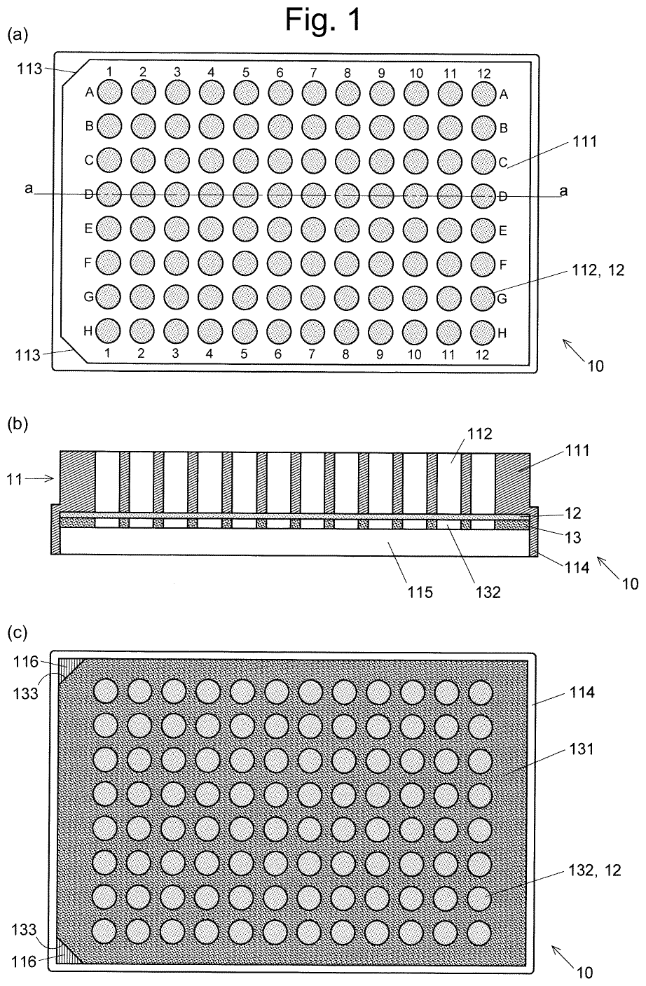

Embodiments of a microplate filter plate (hereinafter, “filter plate”) according to the present invention will be described with reference to FIGS. 1 to 9.

### (1) First Embodiment

FIG. 1 illustrates a filter plate 10 according to a first embodiment. The filter plate 10 includes a base portion 11, a filter sheet 12, and a packing member 13.

The base portion 11 includes a plate-shaped member 111 made of plastic and having a rectangular planar shape, and a plurality of first through holes 112 provided in the plate-shaped member 111 and having a circular planar shape. A total of 96 first through holes 112 are provided such that 12 first through holes are arranged in parallel to the long sides of the rectangle and 8 first through holes are arranged in parallel to the short sides of the rectangle. The arrangement of the first through holes 112 corresponds to the arrangement of wells of a 96-hole microplate on which the filter plate 10 is mounted. In the upper surface of the base portion 11, numbers 1 to 12 are indicated at each of end portions on the long sides in accordance with respective columns in which the first through holes 112 are arranged, and eight alphabets A to H are indicated at each of end portions on the short sides in accordance with respective rows in which the first through holes 112 are arranged. These numbers and alphabets are symbols for specifying the respective first through holes 112.

Surfaces-C 113 cut off at an angle of 45° with respect to one short side are formed at respective two corners adjacent to each other with the one short side interposed therebetween among the four corners of the rectangle of the base portion 11 (plate-shaped member 111). By providing the surfaces-C 113, the direction of the filter plate 10 can be easily recognized.

A rectangular frame-shaped vertical wall 114 made of the same material as that of the base portion 11 extends downward from an outer peripheral edge of the lower surface of the base portion 11. A part below the lower surface and surrounded by the vertical wall 114 is a microplate insertion space 115 into which the 96-hole microplate is inserted. The microplate insertion space 115 is basically a rectangular parallelepiped, but corner portions 116 (see FIG. 1(c)) made of the same material as that of the vertical wall 114 are provided immediately below the portions of the rectangular parallelepiped where the base portion 11 is cut off at the surfaces-C 113. That is, the planar shape of the microplate insertion space 115 and the planar shape of the upper surface of the base portion 11 are substantially the same.

The filter sheet 12 is made of a filter material of nylon 66 and having an aperture (filtration particle size) of 30 μm. One filter sheet 12 has substantially the same shape as that of a region surrounded by the vertical wall 114 in the lower surface of the base portion 11, and is attached to the lower surface of the base portion 11 so as to cover the region. Portions of the one filter sheet 12 facing the first through holes 112 function as a filter of the present invention.

The packing member 13 is made of a plate-shaped member 131 having a thickness larger than that of the filter sheet 12, in which a second through hole 132 at a position corresponding to each of the first through holes 112 of the base portion 11 is formed. The packing member 13 has substantially the same planar shape as that of the filter sheet 12, and is provided on the lower surface of the base portion 11 so as to sandwich the filter sheet 12 therebetween. The plate-shaped member 131 of the packing member 13 is made of silicone rubber and has flexibility.

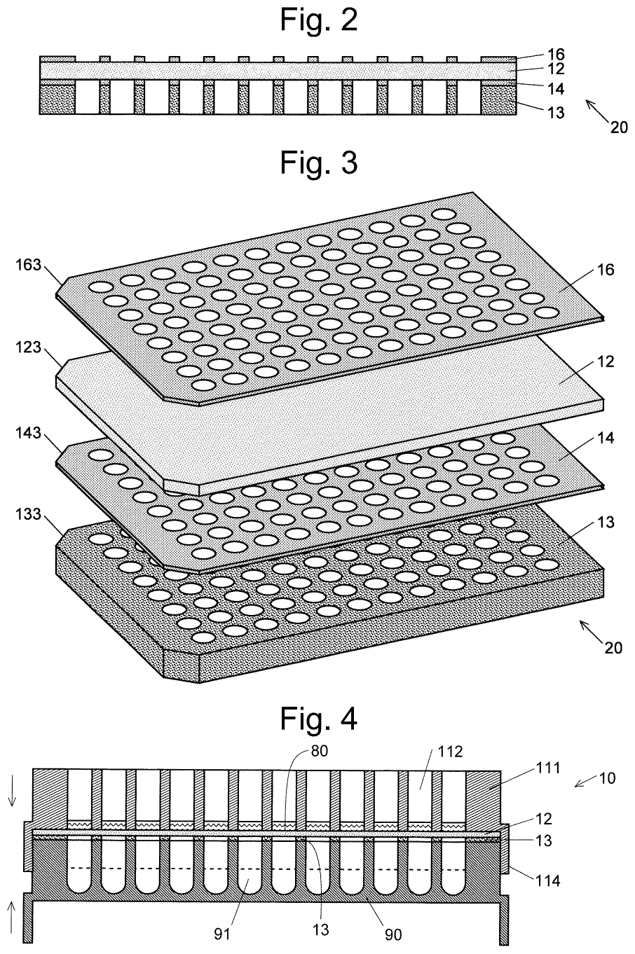

As illustrated in FIGS. 2 and 3, the filter sheet 12 and the packing member 13 are bonded to each other by a first double-sided adhesive film 14 provided with a hole at a position corresponding to each of the second through holes 132 of the packing member 13 (the first double-sided adhesive film 14 is not illustrated in FIG. 1). Note that in FIG. 2, in order to clearly display each component, scales in the horizontal direction and the vertical direction are different (so as to be lengthened in the vertical direction). In addition, the filter sheet 12 and the base portion 11 are bonded to each other with a second double-sided adhesive film 16 (the second double-sided adhesive film 16 is not illustrated in FIG. 1) provided with holes at positions respectively corresponding to the first through holes 112 of the base portion 11. Both the first double-sided adhesive film 14 and the second double-sided adhesive film 16 have the same planar shape as that of the filter sheet 12 or the packing member 13. Therefore, the filter sheet 12, the packing member 13, the first double-sided adhesive film 14, and the second double-sided adhesive film 16 each have two notches of 123, 133, 143, and 163, respectively, at two locations corresponding to the two surfaces-C of the base portion 11 (see FIG. 3).

When the filter plate 10 is manufactured, first, the packing member 13, the first double-sided adhesive film 14, the filter sheet 12, and the second double-sided adhesive film 16 are integrated by overlapping and bonding them in order from the bottom by aligning the respective notches 133, 143, 123, and 163. Next, the integrated body (referred to as “seal 20 with filter/packing member”) is fitted in a space (microplate insertion space 115) surrounded by the vertical wall 114 on the lower surface of the base portion 11 by aligning the notches with the corner portions 116 of the base portion 11, and is attached to the lower surface of the base portion 11 with the second double-sided adhesive film 16. Thus, the filter plate 10 is completed.

Note that a release paper may be attached to one surface of the packing member 13, the release paper may be kept attached to the packing member 13 at the time of manufacturing the seal 20 with filter/packing member and at the time of manufacturing the filter plate 10, and the release paper may be peeled off from the packing member 13 immediately before the filter plate 10 is attached to the microplate. By covering the surface of the packing member 13 with the release paper, it is possible to prevent dust from adhering to the surface of the packing member 13 at the time of manufacturing the seal 20 with filter/packing member and manufacturing the filter plate 10, and further, it is possible to prevent dust from being mixed into the wells of the microplate.

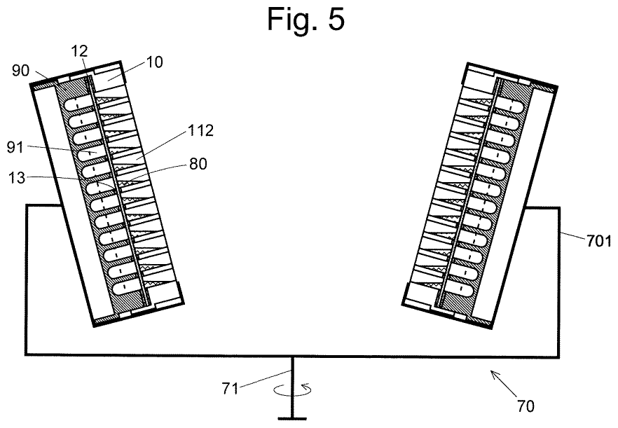

Hereinafter, a method of using the filter plate 10 of the first embodiment will be described with reference to FIGS. 4 and 5.

First, a 96-hole microplate 90 having a shape corresponding to the microplate insertion space 115 of the filter plate 10 is prepared. Then, the surfaces-C of the microplate 90 and the corner portions 116 of the filter plate 10 are aligned, and the microplate 90 is inserted into the microplate insertion space 115 of the filter plate 10 from the upper surface of the microplate 90 (FIG. 4). Next, the microplate 90 and the filter plate 10 are pressed against each other. At this time, since the packing member 13 positioned between the microplate 90 and the base portion 11 has flexibility, the microplate 90 and the filter plate 10 are pressed against each other, so that the microplate 90 and the filter plate 10 are connected in a liquid-tight state without any gap.

Subsequently, a predetermined amount of the sample liquid 80 is dropped into each of the first through holes 112 of the base portion 11 using a micropipette (not illustrated) in a state where the microplate 90 and the filter plate 10 are connected. At this time, it suffices that the dropped sample liquid 80 is placed on the filter, and it is not necessary to strongly press the tip of a chip attached to the nozzle of the micropipette against the surface of the filter. Therefore, it is not necessary to cause the chip to deeply enter the first through hole 112, and it is possible to easily perform an operation of simultaneously dropping the sample liquid 80 into the plurality of first through holes 112 using, for example, a multichannel micropipette having a plurality of nozzles.

After the sample liquid 80 is dropped into the first through holes 112 of the filter plate 10, the microplate 90 and the filter plate 10 are set in a holder 701 of a centrifuge 70 in a state of being inclined substantially vertically (FIG. 5). In order to maintain the close contact state between the microplate 90 set in the holder 701 of the centrifuge 70 and the filter plate 10, the microplate and the filter plate 10 may be fastened with a rubber band, a clip, or the like. Thereafter, the centrifuge 70 is driven to rotate the holder 701 at a high speed about a rotation shaft 71 extending in the vertical direction. As a result, the sample liquid 80 in the first through holes 112 of the filter plate 10 is drawn into the wells 91 of the microplate 90 and filtered when passing through the filter sheet 12.

At this time, since the filter plate 10 and the microplate 90 are connected in a liquid-tight state by the packing member 13 having flexibility, when the sample liquid 80 in the first through holes 112 is drawn into the wells 91 by centrifugal force, the sample liquid is prevented from flowing into the other wells 91. Therefore, it is possible to prevent different sample liquids from being supplied to the wells 91 in a mixed state.

### (2) Second Embodiment

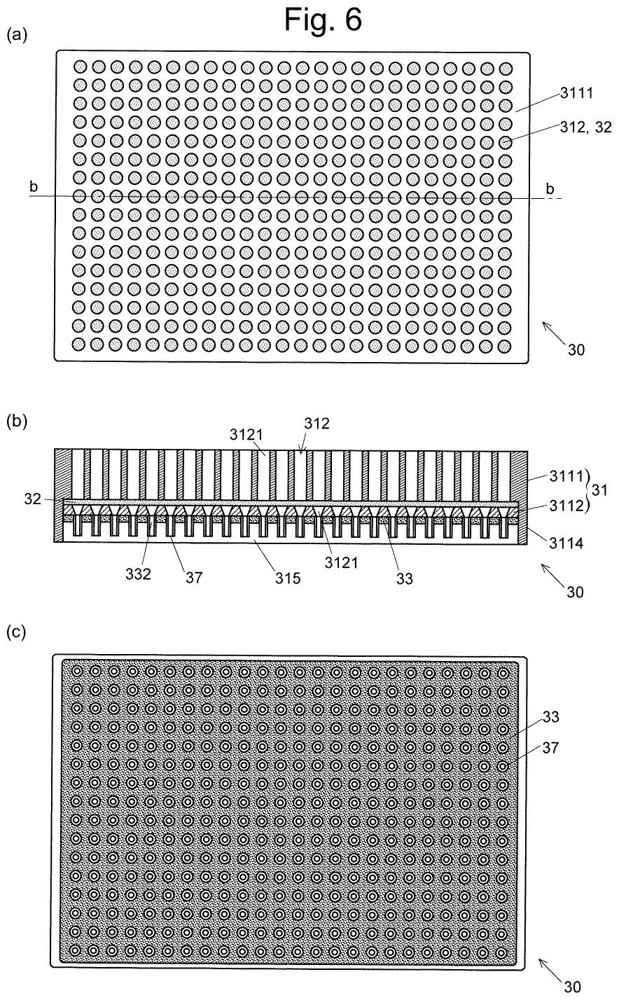

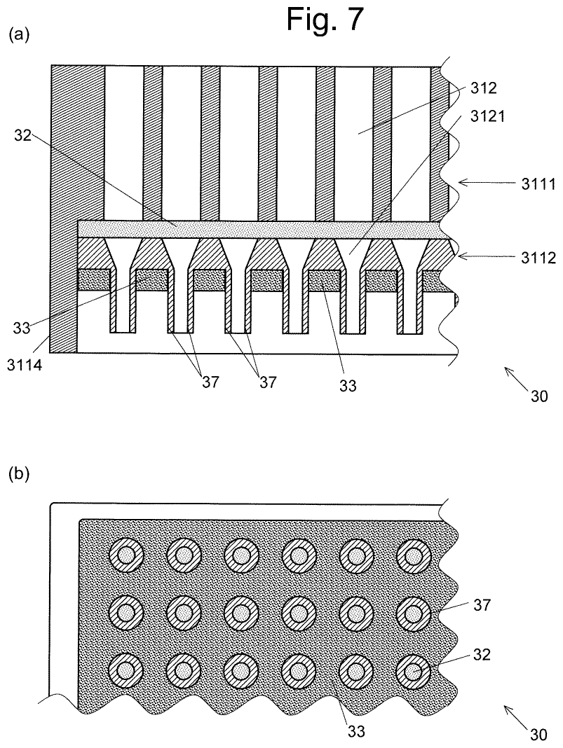

FIGS. 6 and 7 illustrate a filter plate 30 according to a second embodiment. The filter plate 30 includes a base portion 31, a filter sheet 32, a packing member 33, and cylinders 37.

The base portion 31 is formed of a plastic plate-shaped member having a rectangular planar shape, and has a total of 384 first through holes 312 having a circular planar shape and disposed such that 24 first through holes are arranged in parallel to the long sides and 16 first through holes are arranged in parallel to the short sides. The arrangement of the first through holes 312 corresponds to the arrangement of the wells of the 384-hole microplate on which the filter plate 30 is mounted.

The base portion 31 includes a first base portion 3111 and a second base portion 3112 attached to a lower portion of the first base portion 3111. A vertical wall 3114 having a rectangular frame shape extends downward from an outer peripheral edge of the lower surface of the first base portion 3111, and the filter sheet 32 and the second base portion 3112 are attached in this order from the first base portion 3111 side, to a portion surrounded by the vertical wall 3114 of the lower surface of the first base portion 3111. The length of the vertical wall 3114 is larger than the combined thickness of the filter sheet 32 and the second base portion 3112, and a space below the second base portion 3112 and surrounded by the vertical wall 3114 is the microplate insertion space 315. The first base portion 3111 and the second base portion 3112 have 384 through holes 3121 and 3122, respectively, and the first through holes 312 are constituted by the respective through holes 3121 and 3122 positioned correspondingly when the first base portion 3111 and the second base portion 3112 are vertically stacked. Each of the through holes 3121 has a cylindrical shape whose inner diameter is uniform in the depth direction (vertical direction in FIG. 7(a)), whereas each of the through holes 3122 has a tapered shape whose inner diameter is smaller in the lower portion than in the upper portion.

The cylinders 37 are provided on the lower surface of the second base portion 3112 so as to extend downward from the periphery of the respective first through holes 312. The cylinders 37 are made of the same plastic as that of the second base portion 3112, and are integrally molded with the second base portion 3112. The outer diameter of each of the cylinders 37 is slightly smaller than the inner diameter of each of the wells of the 384-hole microplate, and the inner diameter of the cylinder 37 is equal to the inner diameter of the through hole 3122 on the lower surface of the second base portion 3112. The length of the cylinder 37 is shorter than the depth of the well of the 384-hole microplate.

As described above, the filter sheet 32 is interposed between the first base portion 3111 and the second base portion 3112. The material of the filter sheet 32 and the size of the aperture are the same as those of the filter sheet 12 of the first embodiment. In addition, similarly to the first embodiment, the filter sheet 32 covers the entire upper surface of the second base portion 3112, and portions of the filter sheet 32 located in the first through holes 312 function as the filter of the present invention.

The packing member 33 includes a plate-shaped member made of silicone rubber, and is attached to the second base portion 3112 so as to cover a portion other than the cylinders 37 in the lower surface of the second base portion 3112. Therefore, the packing member 33 has the second through hole 332 corresponding to each of the cylinders 37.

Although detailed description and illustration are omitted, the first base portion 3111 and the filter 32, the filter 32 and the second base portion 3112, and the second base portion 3112 and the packing member 33 are bonded to each other with an adhesive or an adhesive sheet with an adhesive applied to both surfaces.

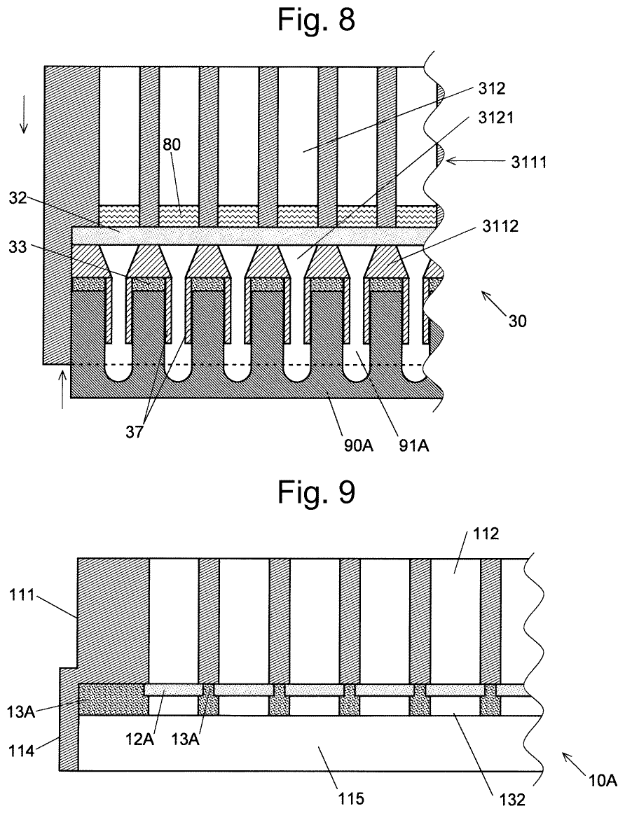

The filter plate 30 is used as follows. First, a (384-hole) microplate 90A having 384 wells 91A is prepared. Then, as illustrated in FIG. 8, the microplate 90A is inserted into the microplate insertion space 315 of the filter plate 30 from the upper surface of the microplate 90A. At that time, the cylinders 37 corresponding to the positions of the wells 91A of the microplate 90A are inserted into the respective wells 91A, respectively. Next, the microplate 90A and the filter plate 30 are pressed against each other. By pressing the microplate 90A and the filter plate 30 in this manner, the packing member 33 having flexibility adheres to the upper surface of the microplate 90A without any gap, whereby the filter plate 30 and the microplate 90A are connected in a liquid-tight state. The operations from the dropping of the sample liquid 80 into the first through holes 312 to the supply of the sample liquid 80 to the wells 91A by the application of the centrifugal force is the same as in the first embodiment.

According to the second embodiment, since the filter plate 30 is connected to the microplate 90A in a liquid-tight state by the packing member 33 having flexibility, when the sample liquid 80 dropped into the first through holes 312 is drawn into the microplate 90A by centrifugal force, the sample liquid 80 is prevented from leaking out and flowing into an adjacent well 91A. In addition, since the cylinders 37 are provided on the lower surface of the base portion 31 of the filter plate 30, the liquid sample that has passed through the filter can be guided to the vicinity of bottom portions of the wells 91A of the microplate 90A.

In the filter plate 30 of the second embodiment, the filter sheet 32 is sandwiched and fixed between the first base portion 3111 and the second base portion 3112, and the filter is strongly stretched in each of the first through holes 312. Therefore, other than the filtration of the sample liquid, for example, it can be used to recover intracellular substances such as intracellular nucleic acids and exosomes contained in blood or cell culture solution.

When an intracellular substance is recovered from cells contained in the sample liquid, the holding tool 701 of the centrifuge 70 is rotated at a higher speed than when the sample liquid is filtered. As a result, a large centrifugal force is generated, and the cells in the sample liquid are strongly pressed against the filter. Since the filter plate 30 is in a state in which the filter is strongly stretched in each of the first through holes 312, a large normal force from the filter acts on the cells strongly pressed against the filter, and the cells can be destroyed by the centrifugal force and the normal force. The destroyed cells and intracellular material can be separated by appropriately setting the aperture of the filter.

### (3) Modifications

The present invention is not limited to the above embodiments, and various modifications are possible. For example, the materials of the base portions 11 and 31, the filter sheets 12 and 32, and the packing members 13 and 33 described in the above embodiments are merely examples, and other materials may be used. For example, as the material of the packing members 13 and 33, ethylene propylene rubber (EPM (EPR) or EPDM (EPT)), urethane rubber, or the like may be used instead of silicone rubber. As the material of the filter sheets 12 and 32, a polymer material such as polyester, polyethylene, and polypropylene may be used instead of the nylon 66, or a material other than the polymer material such as metal may be used.

The aperture of the filter sheets 12 and 32 can be appropriately sized according to the intended use of the filter plate. For example, the aperture can be 1 μm, 10 μm, 40 μm, 70 μm, 100 μm, or the like. Alternatively, a microfiltration filter (membrane filter) having an aperture of less than 1 μm (so-called submicron) may be used. For example, when an exosome is collected as an intracellular substance, the aperture of the filter sheet may be 0.1 μm to 5 μm.

In the first embodiment, the filter plate having the first through holes and the second through holes the number and positions of which correspond to those of the wells of the 96-hole microplate is shown, and in the second embodiment, the filter plate having the first through holes and the second through holes the number and positions of which correspond to those of the wells of the 384-hole microplate is shown. However, the filter plate of the first embodiment and the filter plate of the second embodiment can be applied to various microplates by providing the first through holes and the second through holes the number and positions of which correspond to those of the wells of such microplates.

In the filter plate of the first embodiment, the corner portions 116 are provided in the microplate insertion space 115 of the base portion 11, but the corner portions 116 may be omitted. By omitting the corner portions 116, the filter plate can also be used for a microplate having no surface-C.

In the first and second embodiments, a filter corresponding to all the first through holes is configured by one filter sheet 12 and one filter sheet 32, respectively, but as in a filter plate 10A illustrated in FIG. 9, individual filters 12A may be respectively provided in the plurality of first through holes 112.

In the above embodiments, the planar shape of the first through holes 112 and 312 is circular, but may be a quadrangle such as a square, a hexagon such as a regular hexagon, or other shapes. In addition, the shapes of the longitudinal cross sections of the first through holes 112 and 312 are not limited to the above example.

### Modes

A person skilled in the art can understand that the previously described illustrative embodiment is a specific example of the following modes of the present invention.

(Clause 1) A microplate filter plate (filter plate) according to a mode of the present invention includes:
a) a base portion having a plate shape, the base portion including a first through hole provided at a position corresponding to each of a plurality of wells of a microplate;
b) a filter provided in each of the first through holes; and
c) a packing member having a plate-shape and flexibility, the packing member being provided on one surface of the base portion and having a second through hole at a position corresponding to each of the first through holes.

(Clause 2) A filter plate according to Clause 2 is characterized in that the filter plate according to Clause 1 is configured such that one filter sheet having a size that covers all of a plurality of the first through holes of the base portion is provided between the one surface of the base portion and the packing member.

In the filter plate according to Clause 2, a portion of the filter sheet corresponding to each of the first through holes serves as a filter.

(Clause 3) A filter plate according to Clause 3 is characterized in that the filter plate according to Clause 1 is configured to further include a cylinder extending from the periphery of each of the first through holes of the base portion toward the packing member and passing through each of the second through holes.

(Clause 4) A filter plate according to Clause 4 is characterized in that the filter plate according to Clause 3 is configured such that
the base portion is formed by overlapping a first base portion having a plate shape and a second base portion having the cylinder on one surface of a plate-shaped member, and
the filter is provided between the first base portion and the second base portion.

(Clause 5) A filter plate according to Clause 5 is characterized in that the filter plate according to any one of Clauses 1 to 4 is configured such that a material of the packing member is silicone rubber.

### REFERENCE SIGNS LIST

10, 10A, 30 . . . Filter Plate
11, 31 . . . Base Portion
111 . . . Plate-Shaped Member of Base Portion
112, 312 . . . First Through Hole
113 . . . Surface-C
114 . . . Vertical Wall
115, 315 . . . Microplate Insertion Space
116 . . . Corner Portion
12, 12A, 32 . . . Filter Sheet
123, 133, 143, 153, 163 . . . Notch
13, 13A, 33 . . . Packing Member
131 . . . Plate-Shaped Member of Packing Member
132, 332 . . . Second Through Hole
14 . . . First Double-Sided Adhesive Film
16 . . . Second Double-Sided Adhesive Film
20 . . . Seal with Filter/Packing Member
3111 . . . First Base Portion
3112 . . . Second Base Portion
3121 . . . First Through Hole in Second Base Portion
37 . . . Cylinder
70 . . . Centrifuge
71 . . . Rotation Shaft of Centrifuge
80 . . . Sample Liquid
90, 90A . . . Microplate
91, 91A . . . Well

1. A microplate filter plate comprising:
a) a base portion having a plate shape, the base portion including a through hole provided at a position corresponding to each of a plurality of wells of a microplate;
b) a surrounding wall extending upright from an outer peripheral edge of one surface of the base portion such as to surround the one surface;
c) a filter provided in each of the through holes; and
d) a packing member having a plate shape and flexibility, the packing member being provided on one surface of the base portion entirely except at positions corresponding to the through holes.

2. The microplate filter plate according to claim 1, wherein one filter which covers all of a plurality of the through holes of the base portion is provided between the one surface of the base portion and the packing member.

3. The microplate filter plate according to claim 1 further comprising a cylinder partially forming each of the through holes, the cylinder being provided on one surface of the base portion at a position corresponding to each of the plurality of wells of the microplate.

4. The microplate filter plate according to claim 3, wherein
the base portion is formed by a first base portion having a plate shape and a second base portion having a plate shape and the cylinder, the second base portion being overlapped on one surface of the base portion, and
the filter is provided between the first base portion and the second base portion.

5. The microplate filter plate according to claim 1, wherein a material of the packing member is silicone rubber.
